(19) United States
(12) Patent Application Publication
(10) Pub. No.: US 2026/0289755 A1
(43) Pub. Date: Sep. 24, 2026

(54) VIDEO DELIVERY SYSTEM CAPABLE OF DYNAMIC-RANGE CHANGES

(71) Applicant: DOLBY LABORATORIES LICENSING CORPORATION

(72) Inventors: Tsung-Wei Huang, Fremont, CA (US); Guan-Ming Su, Fremont, CA (US)

(73) Assignee: DOLBY LABORATORIES LICENSING CORPORATION, (US)

(21) Appl. No.: 18/874,181

(22) PCT Filed: Jun. 13, 2023
(86) PCT No.: PCT/US2023/025215

§ 371 Date: Dec. 12, 2024

Related U.S. Application Data
(60) Provisional application No. 63/351,855, filed on Jun. 14, 2022.

(30) Foreign Application Priority Data
Jun. 14, 2022 (EP) 22178928.2

(51) Int. Cl. G06T 5/92; G06T 5/50; H04N 9/64

(52) U.S. Cl. CPC G06T 5/92; G06T 5/50; H04N 9/646; G06T 2207/10016; G06T 2207/10024; G06T 2207/20208

(57) ABSTRACT

A video delivery system comprising: a memory to store a plurality of chroma-offset values corresponding to grid points of a five-dimensional grid; and a processor to convert a input SDR image into a corresponding HDR output image, the processor being configured to: generate an intermediate HDR image by reshaping the input image, the reshaping being performed using a reshaping-function index map having, for each pixel of the intermediate image, a respective index identifying a corresponding reshaping function applied to the pixel; estimate a display-management metadata value corresponding to the intermediate image; and generate the output image by applying a respective chroma offset to each pixel of the intermediate image, the respective chroma offset being determined from the plurality of chroma-offset values by addressing the grid points using the respective index, the display-management metadata value, and three respective pixel values of a corresponding pixel of the input image.

### 1. CROSS-REFERENCE TO RELATED APPLICATIONS

This application claims priority from European patent application 22 178 928.2 and U.S. Provisional patent application Ser. No. 63/351,855, both filed on 14 Jun. 2022, each of which is incorporated by reference in its entirety.

### 2. FIELD OF THE DISCLOSURE

Various example embodiments relate to image-processing operations and, more specifically but not exclusively, to video codecs.

### 3. BACKGROUND

This section introduces aspects that may help facilitate a better understanding of the disclosure. Accordingly, the statements of this section are to be read in this light and are not to be understood as admissions about what is in the prior art or what is not in the prior art.

As used herein, the term “dynamic range” (DR) may relate to a capability of the human visual system (HVS) to perceive a range of intensity (e.g., luminance, luma) in an image, e.g., from darkest blacks (darks) to brightest whites (highlights). In this sense, DR relates to a “scene-referred” intensity. DR may also relate to the ability of a display device to render, adequately or approximately, an intensity range of a particular breadth. In this sense, DR relates to a “display-referred” intensity. Unless a particular sense is explicitly specified to have particular significance at any point in the description herein, it should be inferred that the term may be used in either sense, e.g., interchangeably.

As used herein, the term “high dynamic range” (HDR) relates to a DR breadth that spans 14-15 or more orders of magnitude of the human visual system (HVS). In practice, the DR over which a human may simultaneously perceive an extensive breadth in intensity range may be somewhat truncated, in relation to HDR. As used herein, the terms “enhanced dynamic range” (EDR) or “visual dynamic range” (VDR) may individually or interchangeably relate to the DR that is perceivable within a scene or image by a human visual system that includes eye movements, allowing for some light adaptation changes across the scene or image. Herein, EDR may relate to a DR that spans 5 to 6 orders of magnitude. While perhaps somewhat narrower in relation to true scene-referred HDR, EDR nonetheless represents a wide DR breadth and may also be referred to as HDR.

In practice, images comprise one or more color components (e.g., luma Y and chroma Cb and Cr) of a color space, where each color component is represented with a precision of n-bits per pixel (e.g., n=8). Using non-linear luminance coding (e.g., gamma encoding), images where n≤8 (e.g., 24-bit color JPEG images) are considered images of standard dynamic range (SDR), while images where n>8 may be considered images of enhanced dynamic range.

A reference electro-optical transfer function (EOTF) for a given display characterizes the relationship between color values (e.g., luminance) of an input video signal to output screen color values (e.g., screen luminance) produced by the display. For example, ITU Rec. ITU-R BT. 1886, “Reference electro-optical transfer function for flat panel displays used in HDTV studio production,” (March 2011), which is incorporated herein by reference in its entirety, defines the reference EOTF for flat panel displays. Given a video stream, information about its EOTF may be embedded in the bitstream as (image) metadata. The term “metadata” herein relates to any auxiliary information transmitted as part of the coded bitstream. Such metadata may be used to assist a decoder in rendering a decoded image and may include, but are not limited to, color space or gamut information, reference display parameters, and auxiliary signal parameters, such as those further described herein.

As used herein, the term “PQ” refers to perceptual luminance amplitude quantization. The human visual system responds to increasing light levels in a very nonlinear way. A human's ability to see a stimulus is affected by the luminance of that stimulus, the size of the stimulus, the spatial frequencies making up the stimulus, and the luminance level that the eyes have adapted to at the particular moment one is viewing the stimulus. In some cases, a PQ function may map linear input gray levels to output gray levels that better match the contrast sensitivity thresholds in the human visual system. An example PQ mapping function is described in SMPTE ST 2084:2014 “High Dynamic Range EOTF of Mastering Reference Displays” (hereinafter “SMPTE”), which is incorporated herein by reference in its entirety.

Displays that support luminance of 200 to 1,000 cd/m² or nits typify a lower dynamic range (LDR), also referred to as a standard dynamic range (SDR), in relation to EDR (or HDR). EDR content may be displayed on EDR displays that support higher dynamic ranges (e.g., from 1,000 nits to 5,000 nits or more). Such displays may be defined using alternative EOTFs that support high luminance capability (e.g., 0 to 10,000 or more nits). An example of such an EOTF is defined in SMPTE 2084 and Rec. ITU-R BT.2100, “Image parameter values for high dynamic range television for use in production and international programme exchange,” (June 2017), which are incorporated herein by reference in their entirety.

WO 2022/072884 A1 discloses a method of adaptive local reshaping for SDR-to-HDR up-conversion. A global index value is generated for selecting a global reshaping function for an input image of a relatively low dynamic range using luma codewords in the input image. Image filtering is applied to the input image to generate a filtered image. The filtered values of the filtered image provide a measure of local brightness levels in the input image. Local index values are generated for selecting specific local reshaping functions for the input image using the global index value and the filtered values of the filtered image. A reshaped image of a relatively high dynamic range is generated by reshaping the input image with the specific local reshaping functions selected using the local index values.

WO 2017/059415 A1 discloses a method for color correction in high dynamic range video (HDR) using a 2D look-up table (LUT). The color correction may be applied in a decoder after decoding the HDR video signal. For example, the color correction may be applied before, during, or after chroma upsampling of the HDR video signal. The 2D LUT may include a representation of the color space of the HDR video signal. The color correction may include applying triangle interpolation to the sample values of the color component of the color space. The 2D LUT may be estimated by an encoder and signaled to the decoder. The encoder may decide to reuse a prior-signaled 2D LUT or use a new 2D LUT.

### BRIEF SUMMARY OF SOME SPECIFIC EMBODIMENTS

Disclosed herein are various embodiments of a video delivery system capable of performing color shift correction in HDR images generated from SDR images. In an example embodiment, the color shift correction is performed using a precomputed lookup table (LUT) representing a five-dimensional (5-D) grid, the LUT being addressable using reshaping-function index values, metadata values, hue values, saturation values, and intensity values. Linear interpolation may be used to obtain chroma-offset values for any points of the corresponding 5-D parameter space that are not grid points. Also disclosed herein is an example iterative minimization method employing a suitably constructed cost function that may be used to populate the LUT. Beneficially, an example embodiment of the disclosed color shift correction is compatible with existing display-management functions and does not require any modification thereof.

According to an example embodiment, provided is a video delivery system capable of changing a dynamic range of an input image, the delivery system comprising: a memory to store a plurality of chroma-offset values corresponding to grid points of a five-dimensional grid; and a processor to convert the input image having a first dynamic range into a corresponding output image having a larger second dynamic range, the processor being configured to: generate an intermediate image having the second dynamic range by reshaping the input image, the reshaping being performed using a reshaping-function index map having, for each pixel of the intermediate image, a respective index identifying a corresponding reshaping function applied to the pixel; estimate a display-management metadata value corresponding to the intermediate image; and generate the output image by applying a respective chroma offset to each pixel of the intermediate image, the respective chroma offset being determined from the plurality of chroma-offset values by addressing the grid points using the respective index, the display-management metadata value, and three respective pixel values of a corresponding pixel of the input image.

According to another example embodiment, provided is a method of changing a dynamic range of an input image, the method comprising: converting the input image having a first dynamic range into a corresponding output image having a larger second dynamic range, the converting being performed using a plurality of precomputed chroma-offset values corresponding to grid points of a five-dimensional grid; and wherein said converting comprises: generating an intermediate image having the second dynamic range by reshaping the input image, the reshaping being performed using a reshaping-function index map having, for each pixel of the intermediate image, a respective index identifying a corresponding reshaping function applied to the pixel; estimating a display-management metadata value corresponding to the intermediate image; and generating the output image by applying a respective chroma offset to each pixel of the intermediate image, the respective chroma offset being determined from the plurality of chroma-offset values by addressing the grid points using the respective index, the display-management metadata value, and three respective pixel values of a corresponding pixel of the input image.

According to yet another example embodiment, provided is a non-transitory computer-readable medium storing instructions that, when executed by an electronic processor, cause the electronic processor to perform operations comprising a method of changing a dynamic range of an input image, the method comprising: converting the input image having a first dynamic range into a corresponding output image having a larger second dynamic range, the converting being performed using a plurality of precomputed chroma-offset values corresponding to grid points of a five-dimensional grid; and wherein said converting comprises: generating an intermediate image having the second dynamic range by reshaping the input image, the reshaping being performed using a reshaping-function index map having, for each pixel of the intermediate image, a respective index identifying a corresponding reshaping function applied to the pixel; estimating a display-management metadata value corresponding to the intermediate image; and generating the output image by applying a respective chroma offset to each pixel of the intermediate image, the respective chroma offset being determined from the plurality of chroma-offset values by addressing the grid points using the respective index, the display-management metadata value, and three respective pixel values of a corresponding pixel of the input image.

According to yet another example embodiment, provided is a method of generating a plurality of chroma-offset values for performing color shift correction in an output image generated by changing a dynamic range of an input image, the method comprising: defining a five-dimensional grid with first, second, third, fourth, and fifth dimensions thereof representing reshaping-function index values, metadata values, hue values, saturation values, and intensity values, respectively; defining a cost function for quantifying at least a cost for a hue difference between the input image and the output image; for each grid point of the five-dimensional grid, performing iterative minimization of the cost function to determine a respective set of the chroma-offset values; and arranging the respective sets of the chroma-offset values in an electronic lookup table addressable using sets of discrete values corresponding to the first, second, third, fourth, and fifth dimensions.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 depicts an example process for a video delivery pipeline.

FIG. 2 depicts an example process that can be used in the video delivery pipeline of FIG. 1 according to an embodiment.

FIGS. 3A-3C pictorially illustrate an indexing scheme that can be used in the process of FIG. 2 according to an embodiment.

FIGS. 4A-4C pictorially illustrate an example of calculating interpolation weights that can be used in the process of FIG. 2 according to an embodiment.

FIGS. 5A-5B graphically illustrate an example effect of scaling on the probability distribution function of the luminance Y according to an embodiment.

FIGS. 6A-6B graphically illustrate example grids for the YCbCr and RGB color spaces, respectively, according to various embodiments.

FIG. 7 is a flowchart illustrating a method of populating a 5-D LUT for the process of FIG. 2 according to an embodiment.

FIG. 8 is a flowchart illustrating iterative-minimization processing of the method of FIG. 7 according to an embodiment.

### DETAILED DESCRIPTION

This disclosure and aspects thereof can be embodied in various forms, including hardware, devices or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing is intended solely to give a general idea of various aspects of the present disclosure, and does not limit the scope of the disclosure in any way.

In the following description, numerous details are set forth, such as optical device configurations, timings, operations, and the like, in order to provide an understanding of one or more aspects of the present disclosure. It will be readily apparent to one skilled in the art that these specific details are merely exemplary and not intended to limit the scope of this application.

Moreover, while the present disclosure focuses mainly on examples in which the various circuits are used in digital projection systems, it will be understood that these are merely examples. It will further be understood that the disclosed systems and methods can be used in any device in which there is a need to project light, for example, cinema, consumer, and other commercial projection systems, heads-up displays, virtual reality displays, and the like. Disclosed systems and methods may be implemented in additional display devices, such as with an OLED display, an LCD display, a quantum dot display, or the like.

Many consumer desktop displays may support luminance of 200 to 300 cd/m² or nits. Many consumer HDTVs range from 300 to 500 nits, with new models reaching 1000 nits (cd/m²). As the availability of HDR content grows due to advances in both image-capture equipment (e.g., cameras) and HDR displays (e.g., the PRM-4200 professional reference monitor from Dolby Laboratories), HDR content may be color graded and displayed on HDR displays that support higher dynamic ranges (e.g., from 1,000 nits to 5,000 nits or more).

Some embodiments may benefit from at least some features disclosed in the international patent application by T-W. Huang, et al., “ADAPTIVE LOCAL RESHAPING FOR SDR-TO-HDR UP-CONVERSION,” PCT/US2021/053241, filed Oct. 1, 2021, which is incorporated herein by reference in its entirety.

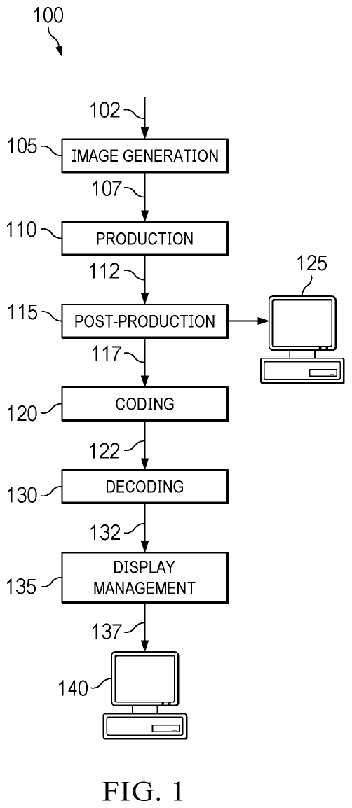

Herein, the term “metadata” relates to any auxiliary information that is transmitted as part of the coded bitstream and assists a decoder in rendering the corresponding image(s). For television broadcasting and video streaming, video metadata may be used to provide side information about specific video and audio streams or files. Metadata can either be embedded directly into the video or be included as a separate file within a container, such as the MP4 or MKV. Metadata may include information about the entire video stream or file or about specific video frames. Created by cameras, encoders, and other video-processing elements (e.g., see 115, 120, FIG. 1), metadata may include but are not limited to timestamps, video resolution, digital film-grain parameters, color space or gamut information, reference display parameters, auxiliary signal parameters, file size, closed captioning, audio languages, ad-insertion points, color spaces, error messages, and so on. Additional examples of metadata pertinent to the disclosed embodiments are described herein below.

In some embodiments disclosed herein below, the image metadata comprise L1 metadata. As used herein, the term “L1 metadata” denotes one or more of minimum (L1-min), medium (L1-mid), and maximum (L1-max) luminance values related to a particular portion of the video content, e.g., an input frame or image. L1 metadata are related to a video signal. In order to generate L1 metadata, a pixel-level, frame-by-frame analysis of the video content is performed, preferably at the encoding side. Alternatively, the analysis may be performed on the decoding side. The analysis describes the distribution of luminance values over defined portions of the video content as covered by an analysis pass, for example a single frame or a series of frames like a scene. L1 metadata may be calculated in an analysis pass covering single video frames and/or series of frames like a scene. L1 metadata may comprise various values that are derived during the analysis pass, together forming the L1 metadata associated with the respective portion of the video content from which the L1 metadata have been calculated and associated with the video signal. Such L1 metadata may comprise at least one of (i) an L1-min value representing the lowest black level in the respective portion of the video content, (ii) an L1-mid value representing the average luminance level across the respective portion of the video content, and (iii) an L1-max value representing the highest luminance level in the respective portion of the video content. The L1 metadata may be generated for and attached to each video frame and/or to each scene encoded in the video signal. L1 metadata may also be generated for regions of an image, and such L1 metadata may be referred to as local L1 values. L1 metadata may be computed by converting RGB data to a luma-chroma format (e.g., YCbCr) and then computing one or more of min, mid (average), and max values in the Y plane, or they can be computed directly in the RGB space.

In some embodiments, an L1-min value may denote the minimum of the PQ-encoded min(RGB) values of the respective portion of the video content (e.g. a video frame or image), while taking into consideration only an active area (e.g., by excluding gray or black bars, letterbox bars, and the like), where min(RGB) denotes the minimum of color component values {R, G, B} of a pixel. The L1-mid and L1-max values may also be computed in a similar fashion. In particular, in an example embodiment, L1-mid may denote the average of the PQ-encoded max(RGB) values of the image, and L1-max may denote the maximum of the PQ-encoded max(RGB) values of the image, where max(RGB) denotes the maximum of color component values {R, G, B} of a pixel. In some embodiments, L1 metadata may be normalized to be in the range [0, 1].

### Video Coding According to Example Embodiments

FIG. 1 depicts an example process of a video delivery pipeline (100), showing various stages from video capture to video-content display according to an embodiment. A sequence of video frames (102) may be captured or generated using an image-generation block (105). The video frames (102) may be digitally captured (e.g., by a digital camera) or generated by a computer (e.g., using computer animation) to provide video data (107). Alternatively, the video frames (102) may be captured on film by a film camera. Then, the film may be translated into a digital format to provide the video data (107).

In a production phase (110), the video data (107) may be edited to provide a video production stream (112). The data of the video production stream (112) may then be provided to a processor (or one or more processors, such as a central processing unit, CPU) at a post-production block (115) for post-production editing. The post-production editing of the block (115) may include, e.g., adjusting or modifying colors or brightness in particular areas of an image to enhance the image quality or achieve a particular appearance for the image in accordance with the video creator's creative intent. This part of post-production editing is sometimes referred to as “color timing” or “color grading.” Other editing (e.g., scene selection and sequencing, image cropping, addition of computer-generated visual special effects, etc.) may be performed at the block (115) to yield a “final” version (117) of the production for distribution. During the post-production editing (115), video images may be viewed on a reference display (125).

Following the post-production (115), video data of the final version (117) may be delivered to a coding block (120) for being delivered downstream to decoding and playback devices, such as television sets, set-top boxes, movie theaters, and the like. In some embodiments, the coding block (120) may include audio and video encoders, such as those defined by the ATSC, DVB, DVD, Blu-Ray, and other delivery formats, to generate a coded bitstream (122). Some methods described herein below may be performed by the corresponding processor at the coding block (120). For example, the coding block (120) may be configured to perform SDR-to-HDR local reshaping and color shift correction as described in more detail below. In a receiver, the coded bitstream (122) is decoded by a decoding unit (130) to generate a corresponding decoded signal (132) representing a copy or a close approximation of the signal (117). The receiver may be attached to a target display (140) that may have somewhat or completely different characteristics than the reference display (125). In such cases, a display management (DM) block (135) may be used to map the decoded signal (132) to the characteristics of the target display (140) by generating a display-mapped signal (137). Some methods described herein below may be performed by the decoding unit (130) and/or display management block (135). Depending on the embodiment, the decoding unit (130) and display management block (135) may include individual processors or may be based on a single integrated processing unit.

In an example embodiment, the SDR-to-HDR local reshaping may take a three-channel (Y, Cb, Cr) input SDR image and predict a three-channel (Y, Cb, Cr) output HDR image using pretrained reshaping functions. To watch the HDR image on the target display (140), the DM block (135) may further process the HDR image based on the corresponding metadata to generate the display-mapped signal (137) representing the DM image according to the target display luminance.

In most cases, the chromaticity of the HDR image and of the DM image is equal or close to that of the SDR image, even though the luminance may be different due to the up-conversion and enhancement. However, in some cases, the difference in chromaticity may become noticeable, and such difference is referred-to as the SDR-to-HDR color shift. The SDR-to-HDR color shift might arise due for several reasons. For example, because the pretrained reshaping functions and DM are typically trained on natural images, such training may cause a larger error and/or color shift on colors less prevalent in natural images. In addition, the DM block (135) may perform clipping on the pixels near the color space boundaries, thereby amplifying an existing color shift or introducing a new color shift.

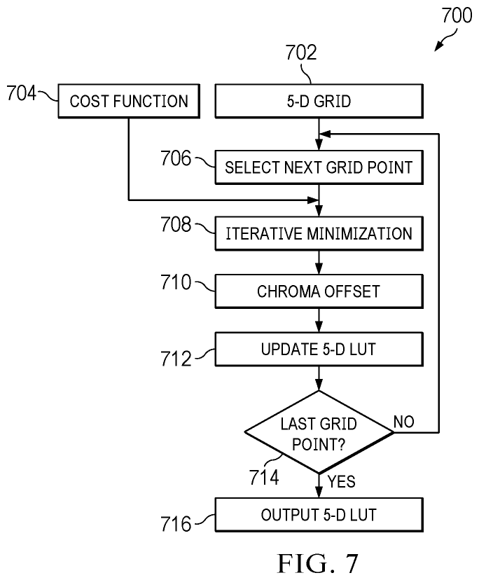

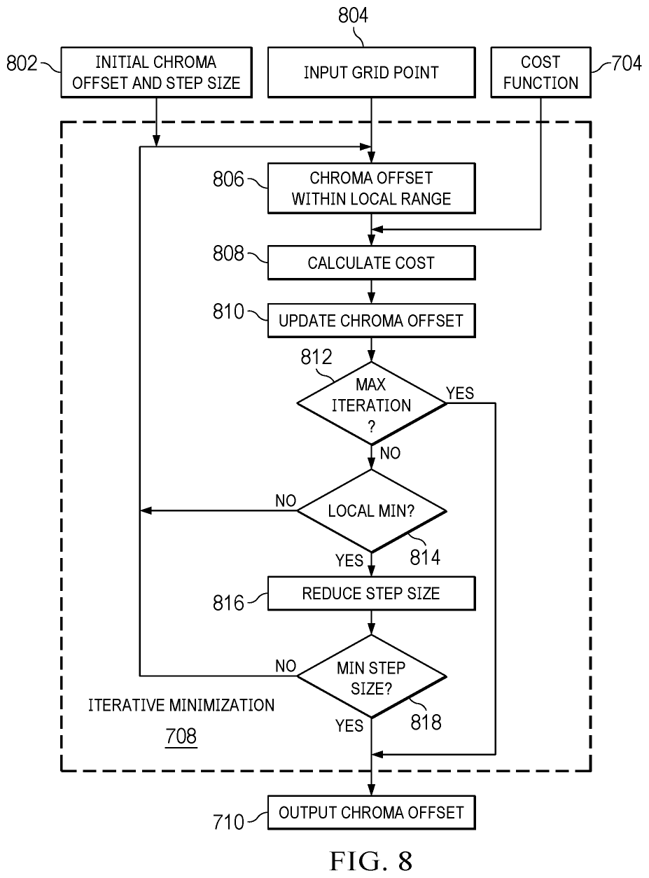

In an example embodiment, the DM block (135) is not modified, e.g., it may remain the same as in the legacy video delivery pipeline. Rather, an example embodiment of the proposed color-shift correction framework is designed to correct the end-to-end color shift between the SDR image and the final DM image by adding a chroma offset to Cb and Cr channels of the HDR image. Because the end-to-end process from the SDR image to the DM image is typically highly nonlinear, the needed chroma offset is determined using a five-dimensional (5-D) lookup table (LUT) on a 5-D grid, wherein the 5 dimensions are the SDR pixel values (three dimensions), the reshaping function indices, and the DM metadata L1-mid. The resulting 5-D space is referred to herein as the HSWLM space, where H stands for hue, S stands for saturation, W stands for scaled intensity value, L stands for local reshaping function index, and M stands for metadata. The 5-D LUT can be populated using a suitable cost function by way of iterative minimization, e.g., as further detailed below in reference to FIGS. 7-8.

### Color Shift Correction

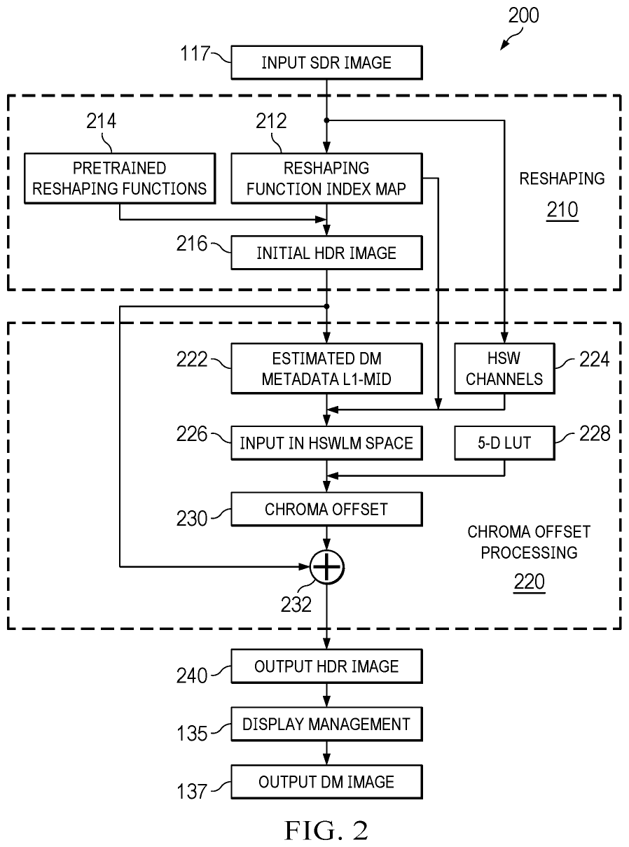

FIG. 2 depicts an example process (200) of the video delivery pipeline (100) according to an embodiment. The process (200) may typically receive an input SDR image (117) and may produce a corresponding output DM image (137) (also see FIG. 1). During the process (200), a chroma offset can be added to an initial HDR image (216) such that a possible color shift arising for the above-indicated reasons may be mitigated.

The process (200) comprises a reshaping block (210) and a chroma offset processing block (220). The reshaping block (210) is configured to generate the initial HDR image (216) based on the input SDR image (117). The reshaping block (210) includes processing directed at generating a reshaping-function index map (212) and applying pretrained reshaping functions (214) to the input SDR image (117). In some embodiments, the reshaping block (210) can be implemented as disclosed in the above-cited international patent application PCT/US2021/053241.

In an example embodiment, the reshaping block (210) includes SDR-to-HDR local reshaping, wherein a three-channel (Y, Cb, Cr) output HDR image (216) is predicted using a three-channel (Y, Cb, Cr) input SDR image (117) and a set of the pretrained reshaping functions (214). The reshaping function index map (212) is created to indicate which of the reshaping functions (214) are used for different pixels.

Let us denote the Y, Cb, and Cr channels of the i-th pixel in the input SDR image S (117) as

$${s}_{i}^{Y C b C r} = ( {s}_{i}^{Y} , {s}_{i}^{C b} , {s}_{i}^{C r} )$$

and the reshaping function index of the i-th pixel in the reshaping function index map L (212) as lᵢ. The i-th pixel

$${v}_{i}^{( init ) , Y CbCr} = ( {v}_{i}^{( init ) , Y} , {v}_{i}^{( init ) , Cb} , {v}_{i}^{( init ) , Cr} )$$

in the initial HDR image V^{(init)} (216) generated by the SDR-to-HDR local reshaping of the reshaping block (210) can be represented as:

$${v}_{i}^{( i n it ) , YCbCr} = {f}_{{l}_{i}}^{( B )} ( {s}_{i}^{YCbCr} ) \qquad ( 1 )$$

where

$${f}_{{l}_{i}}^{( B )}$$

is the lᵢ-th reshaping function. Note that various embodiments are not limited to certain kinds of reshaping functions. For example, the functions

$${f}_{{l}_{i}}^{( B )}$$

can be any suitable reshaping functions, such as LUT-implemented functions and multivariate multiple regression functions.

As a non-limiting example, processing of a single image/frame is described below. Based on the provided description, a person of ordinary skill in the pertinent art will be able to implement the corresponding processing of multiple frames without any undue experimentation, e.g., because the disclosed processing does not typically or explicitly rely on temporal information. For purposes of simplifying the description and without any implied limitations, the description is provided for normalized pixel values, i.e., the values belonging to the range [0,1]. Also, the description assumes that conversion between the color spaces can be performed when needed. For example, if one has the value of

$${s}_{i}^{YCbCr}$$

in the YCbCr color space, then it is assumed that one also has the corresponding value of

$${s}_{i}^{RGB}$$

in the RGB color space. A person of ordinary skill in the pertinent art will readily understand how to perform such conversion between the color spaces.

To watch an HDR image, e.g., the initial HDR image (216) or an output HDR image (240) on the target display (140), processing of the DM block (135) is typically applied to the HDR image, with the result of such DM processing being the output DM image (137). Such DM processing may be controlled by the above-mentioned metadata L1-min, L1-mid, and L1-max, which represent the minimum, mean, and maximum values, respectively, of the RGB channels of the HDR image. However, in an example SDR-to-HDR up-conversion scenario, the L1-min and L1-max may be set to constant values, in at least some cases. As such, some embodiments may rely exclusively on the Lt-mid values.

When the chroma offset processing block (220) is absent, the initial HDR image (216) is applied directly to the DM block (135). Let us denote the R, G and B channels of the i-th pixel in the initial HDR image

$${V}^{( init )} ( 2 \; 16 ) as {v}_{i}^{( init ) , RGB} = ( {v}_{i}^{( init ) , R} , {v}_{i}^{( init ) , G} , {v}_{i}^{( init ) , B} ) .$$

The DM metadata L1-mid of the initial HDR image can be calculated as:

$${m}^{( i n i t )} = \frac{1}{3 N} {\sum }_{i = 0}^{N - 1} {v}_{i}^{( i n it ) , R} + {v}_{i}^{( i n it ) , G} + {v}_{i}^{( init ) , B} \qquad ( 2 )$$

where N is the number of pixels. Let us denote the output DM image generated from the initial HDR image (216) as Ŝ^{(init)}. The i-th pixel

$${\hat{s}}_{i}^{( i n it ) , YCbCr} = ( {\hat{s}}_{i}^{( init ) , Y} , {\hat{s}}_{i}^{( init ) , Cb} , {\hat{s}}_{i}^{( init ) , Cr} )$$

in Ŝ^{(init)} can then be represented as:

$${\hat{s}}_{i}^{( i n it ) , YCbCr} = {f}^{( D M )} ( {v}_{i}^{( i nit ) , YCbCr} , {m}^{( init ) ,} ) \qquad ( 3 )$$

where ƒ^{(DM)} represents the DM function. In various embodiments, the function ƒ^{(DM)} may be the same function as in the legacy video delivery pipelines. In general, various embodiments are not limited to only specific kinds of DM functions.

In some cases,

$${\hat{s}}_{i}^{( i nit ) , YCbCr} and {s}_{i}^{YCbCr}$$

may have similar chromaticity. However, in some other cases, the chromaticity difference, i.e., color shift, between

$${\hat{s}}_{i}^{( init ) , YCbCr} and {s}_{i}^{YCbCr}$$

may be noticeable to the viewer. The processing implemented in the chroma offset processing block (220) is therefore directed at significantly reducing or completely eliminating such difference. In an example embodiment, the chroma offset processing block (220) uses a 5-D grid and a corresponding 5-D LUT (228).

A grid of dimension D (e.g., D=5) can be constructed by sampling along each dimension in the corresponding multi-dimensional space [symbol] ^{D}. For computational efficiency, a uniformly spaced grid can be used, wherein the coordinate values in the same dimension are uniformly sampled. Let us assume that for the d-th dimension, N_{d} values are sampled starting from the initial value p_{d} with spacing b_{d}. Then, the i_{d}-th sample can be calculated as p_{d}+i_{d}b_{d}, where i_{d}=0, 1, . . . , N_{d}−1, and d=0, 1, . . . , D−1. This sampling defines a grid X such that a grid point Xᵢ with the index i=(i₀, i₁, . . . , i_{D-1}) is expressed as follows:

$${X}_{i} = {X}_{{i}_{0} , {i}_{1} , {i}_{2} , … , {i}_{D - 1}} = ( {p}_{0} + {i}_{0} {b}_{0} , {p}_{1} + {i}_{1} {b}_{1} , … , {p}_{D - 1} + {i}_{D - 1} {b}_{D - 1} ) \qquad ( 4 )$$

In general, a LUT, such as the 5-D LUT (228), can be constructed to model an arbitrary function φ on a grid. More specifically, a LUT function Φ on a grid X can be defined such that, for each input grid point Xᵢ, the LUT can return a corresponding output value Φᵢ=φ(Xᵢ). For example, in one embodiment, the function Φ can be a LUT representing the function φ which takes SDR pixel values, a reshaping function index, and the DM metadata L1-mid as an input and then provides the chroma offset as an output. In various embodiments, the outputs of the functions φ and Φ can be in a scalar form or a vector form. In a non-limiting example described below, the output is a 2-D vector for the chroma offset in the Cb and Cr channels.

In an example embodiment, to handle the input values that do not fall on the grid, linear interpolation may be used. For example, such linear interpolation may follow a definition that is similar to that used in conventional bilinear interpolation or trilinear interpolation, wherein the output value is based on a corresponding linear interpolation in each dimension. To facilitate computation, an example embodiment may rely on the normalized grid coordinate. This approach provides a normalized grid that starts from 0 and goes with the unity spacing. Given an input x=(x₀, x₁, . . . , x_{D-1}), the corresponding normalized grid coordinate can be defined as z=(z₀, z₁, . . . , z_{D-1}) by way of shifting and scaling such that:

$${\tilde{x}}_{d} = ( {x}_{d} - {p}_{d} ) / {b}_{d} \qquad ( 5 )$$

From equation (5), it can be seen that a grid \tilde{X} transformed to the normalized grid coordinate starts from 0 and goes with spacing of 1 in all dimensions. In other words, the grid \tilde{X} can be mathematically expressed as \tilde{X}ᵢ=i, where i is an integer counter.

It can further be noted that the normalized grid \tilde{X} forms (N₀−1)×(N₁−1)× . . . ×(N_{D-1}−1) unit hypercubes. These hypercubes can be indexed in the same manner as the grid points. For example, a hypercube denoted as \tilde{C}ᵢ can be the hypercube whose bottom-left vertex, i.e., the vertex that is closest to the origin, is i. Therefore, the 2^{D} vertices of the hypercube \tilde{C}ᵢ are i+{0,1}^{D}.

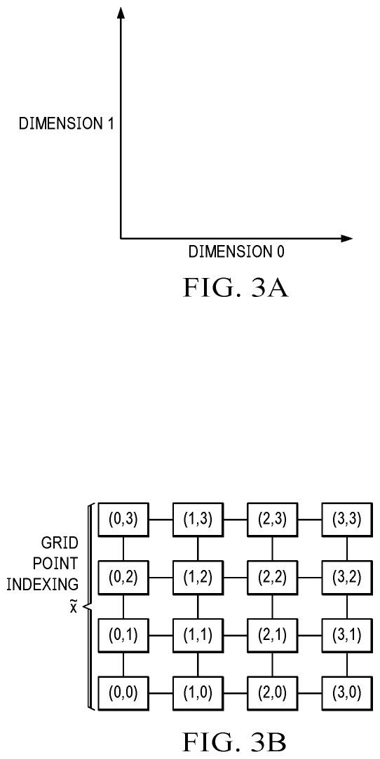

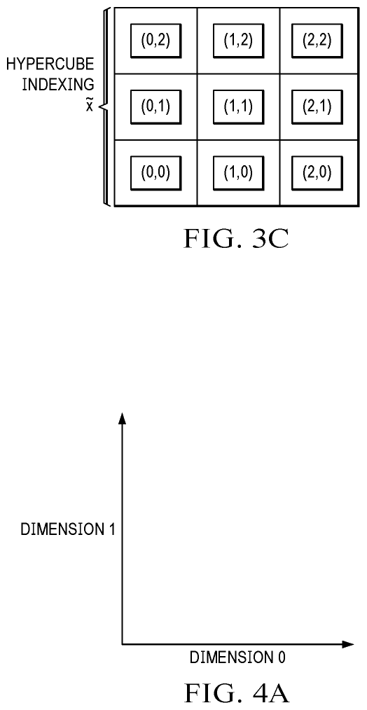

FIGS. 3A-3C pictorially illustrate application of the above-described indexing scheme to an example 2-D grid \tilde{X} of size 4×4 according to an embodiment. More specifically, FIG. 3A illustrates the two grid dimensions, which are denoted as Dimension 0 and Dimension 1, respectively. FIG. 3B illustrates indexing, wherein the grid points (shown as nodes) are indexed as described above. FIG. 3C illustrates indexing, wherein the hypercubes are indexed as described above.

Because linear interpolation is linear in each dimension, such linear interpolation can be performed using the normalized coordinate \tilde{x} and normalized grid \tilde{X} instead of the corresponding non-normalized entities x and X. In an example embodiment, the processing step of performing a linear interpolation may include sub-steps of finding the unit hypercube into which the value of \tilde{x} falls, and then using the distances between \tilde{x} and the vertices of said unit hypercube to perform the interpolation. The index of the unit hypercube that \tilde{x} lays in is denoted as [symbol] (\tilde{x})=(clip3(└\tilde{x}₀┘, 0, N₀−2), clip3(└\tilde{x}₁┘, 0, N₁−2), . . . , clip3(└\tilde{x}_{D-1}┘, 0, N_{D-1}−2)). The clipping function clip3 is defined as clip3(x, a, b)=min(max(x, a), b). It can be noted that when \tilde{x} is on the boundary between hypercubes, that particular \tilde{x} is assigned to the hypercube located in the direction that is pointing away from the origin.

Let us denote the interpolation result of input x as \hat{φ}(x). Based on the above definition of linear interpolation, the interpolation result \hat{φ}(x) can be expressed as:

$$\hat{ϕ} ( x ) = {\sum }_{{i}^{′} ∈ 𝒩 ( \tilde{x} )} w ( \tilde{x} , {i}^{′} ) {Φ}_{{i}^{′}} \qquad ( 6 )$$

where J [symbol] (\tilde{x})= [symbol] (\tilde{x})+{0,1}^{D} is the neighborhood of z. The interpolation weight of i′, denoted as w(\tilde{x}, i′), can be expressed as:

$$w ( \tilde{x} , {i}^{′} ) = {\prod }_{d = 0}^{D - 1} {w}_{d} ( {\tilde{x}}_{d} , {i}_{d}^{′} ) where {w}_{d} ( {\tilde{x}}_{d} , {i}_{d}^{′} ) = 1 - \vert \tilde{x} - {i}_{d}^{′} \vert \qquad ( 7 )$$

It can be noted that the normalization factor in this linear interpolation is already handled because the normalized grid has the spacing of 1. In an example embodiment, when the grid is relatively dense, the interpolation result \hat{φ}(x) may typically be very close to the actual function output φ(x).

Because the weights of the above-described linear interpolation depend only on the distance between \tilde{x} and \tilde{X}_{i′} within the same unit hypercube, for computational efficiency, the weights can be pre-calculated for a plurality of possible distances to enable a lookup thereof at runtime. For example, the unit hypercube can be quantized, and the corresponding interpolation weights can be stored in a LUT. When the quantization is relatively dense, the output of the LUT will typically be relatively close to the corresponding non-quantized interpolation result.

Let us consider a unit hypercube located at the origin. Such a unit hypercube has 2^{D} vertices [symbol] ={0,1}^{D}. In an example embodiment, the vertices can be indexed by their coordinate, i.e., [symbol] ₖ=k=(k₀, k₁, . . . , k_{D-1}). Assuming that the unit hypercube is uniformly quantized to M_{d} points in the closed interval [0,1] for each dimension d=0, 1, . . . , D−1, the quantization grid Q can be defined such that the quantization point with index j=(j₀, j₁, . . . j_{D-1}) is expressed as:

$${Q}_{j} = {Q}_{{j}_{0} , {j}_{1} , … {j}_{D - 1}} = ( \frac{{j}_{0}}{{M}_{0} - 1} , \frac{{j}_{1}}{{M}_{1} - 1} , … , \frac{{j}_{D - 1}}{{M}_{D - 1} - 1} ) \qquad ( 8 )$$

where 0≤j_{d}≤M_{d}−1∀d=0, 1, . . . , D−1.

For the node Qⱼ, the linear interpolation weight of vertex k can be calculated as:

$${W}_{j , k} = {\prod }_{d = 0}^{D - 1} 1 - \vert {Q}_{j , d} - {k}_{d} \vert \qquad ( 9 )$$

Using equation (9), all possible weights W_{j,k} can be pre-calculated and saved in a LUT W having the size M₀×M₁× . . . ×M_{D-1}. The output of the LUT W may include the linear interpolation weights of all of the 2^{D} vertices of the unit hypercube.

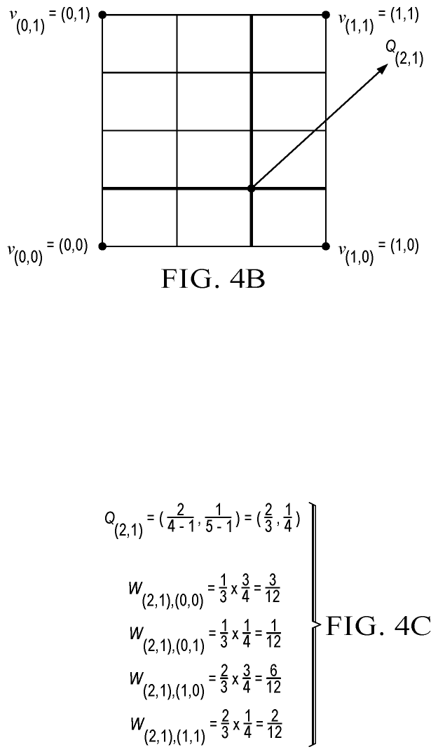

FIGS. 4A-4C illustrate an example of calculating interpolation weights in a 2-D unit hypercube with the quantization grid Q having the size of 4×5 according to an embodiment. More specifically, FIG. 4A illustrates two dimensions of the unit hypercube, which are denoted as Dimension 0 and Dimension 1, respectively. FIG. 4B illustrates the quantization grid Q for the two dimensions of the unit hypercube, with the indices of the corresponding four vertices [symbol] ₖ=k=(k₀, k₁, . . . , k_{D-1}) being explicitly shown. FIG. 4C shows the coordinates of the node Q_{2,1} and the corresponding calculated weights for the four vertices of the unit hypercube shown in FIG. 4B.

To use the LUT W, for an input q=(q₀, q₁, . . . , q_{D-1}) inside the unit hypercube, the input is mapped to the closest node Qⱼ located in the direction towards the origin, where:

$${j}_{d} = ⌊ {q}_{d} ( {M}_{d} - 1 ) ⌋ ∀ d = 0 , 1 , … , D - 1 \qquad ( 10 )$$

For an arbitrary input \tilde{x} and \tilde{X}_{i′}, the mapping operation may include translating the hypercube in which the input \tilde{x} and \tilde{X}_{i′} is located to the unit hypercube located at the origin so that q=\tilde{x}− [symbol] (\tilde{x}) and k=i′− [symbol] (\tilde{x}). Equations (6) and (7) can be transformed into the following equations:

[symbol]

$$\hat{ϕ} ( x ) = {\sum }_{{i}^{′} ∈ 𝒩 ( \tilde{x} )} {W}_{j , k} {Φ}_{{i}^{′}} \qquad ( 11 )$$

$$where$$

$${j}_{d} = ⌊ {q}_{d} ( {M}_{d} - 1 ) ⌋ ∀ d = 0 , 1 , … , D - 1$$

$$q = \tilde{x} - ℋ ( \tilde{x} )$$

$$k = {i}^{′} - ℋ ( \tilde{x} )$$

In an example embodiment, the 5-D grid X can be defined in the above-mentioned HSWLM space. To have better numerical stability and interpolation quality, the 5-D grid X can be aligned with the boundary of valid input-parameter space. Such alignment may typically help with properly performing interpolations for input points located close to the boundary. For the reshaping function index and DM metadata L1-mid, their original values can be used for the grid X because said values are independent (decoupled) from the other dimensions. For example, changing the reshaping function index and DM metadata L1-mid does not make the otherwise valid input invalid. On the other hand, for SDR pixel values, if the YCbCr color space is used, then not all combinations of

$$0 \leq {s}_{i}^{Y} , {s}_{i}^{C b} , {s}_{i}^{C r} \leq 1$$

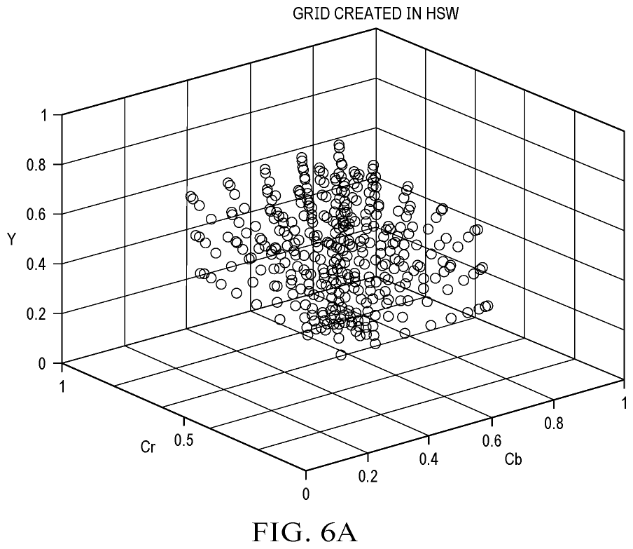

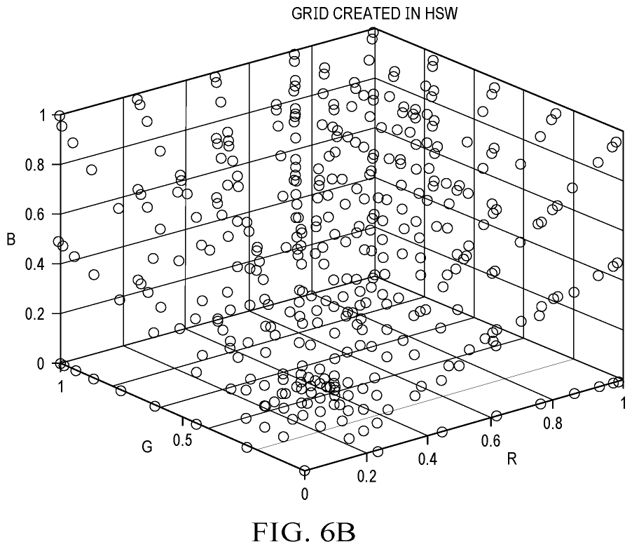

are valid. One way of preventing invalid inputs in the YCbCr color space is to cross-reference the YCbCr inputs to other color spaces. For example, in the RGB or HSV color space, all [0,1]-value combinations are valid (also see FIG. 6B). Herein, RGB stands for red, green, blue; and HSV stands for hue, saturation, value.

In an example embodiment, a scaled HSV color space for the grid creation can be designed such that the density of the grid is proportional to a perceptual hue difference. For example, the V component can be scaled in a nonlinear way such that the density of the grid remains approximately the same at different luminance values. Let us denote the H, S and V channels of the i-th pixel in the input SDR image

$$S ( 1 \; 17 ) as {s}_{i}^{HV} = ( {s}_{i}^{H} , {s}_{i}^{s} , {s}_{i}^{V} ) .$$

The HSW color space can then be defined such that

$${s}_{i}^{H S W} = ( {s}_{i}^{H} , {s}_{i}^{S} , {s}_{i}^{W} )$$

where:

$${s}_{i}^{W} = 1 - {( 1 - {s}_{i}^{V} )}^{0.5} \qquad ( 12 )$$

$$and$$

$${s}_{i}^{V} = 2 {s}_{i}^{W} - {( {s}_{i}^{W} )}^{2}$$

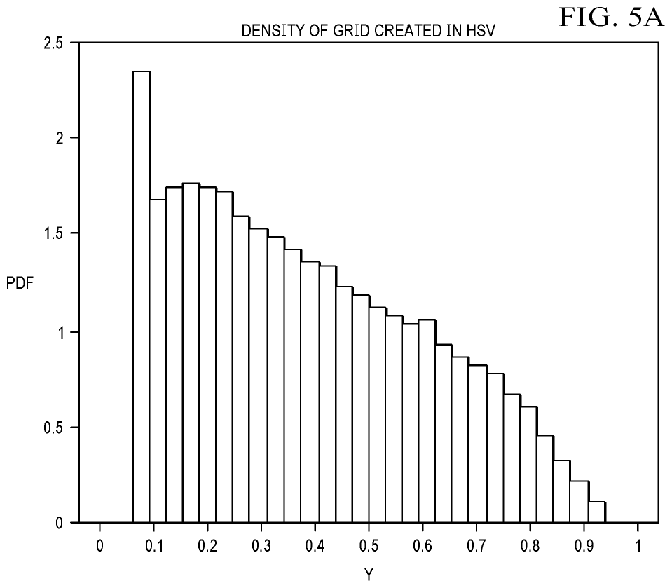

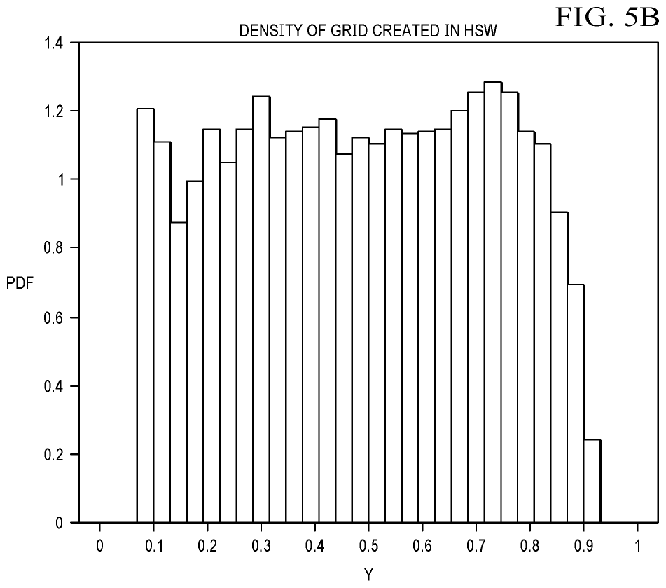

FIGS. 5A-5B graphically illustrate the effect of V-to-W scaling on the probability distribution function (PDF) of the luminance Y according to an embodiment. The scaling can be performed, e.g., in an HSW channels block (224) of the process (200). In this particular example, FIG. 5A graphically illustrates the PDF as a function of the luminance Y for the grid created in the HSV color space and then transformed to the YCbCr color space. FIG. 5B graphically illustrates the PDF as a function of the luminance Y for the grid created in the HSW color space and then transformed to the YCbCr color space. A comparison of the two PDFs reveals that the PDF of FIG. 5B is beneficially more uniform than the PDF of FIG. 5A. Herein, the luminance Y is in the typical SMPTE range, where SMPTE stands for Society of Motion Picture and Television Engineers.

FIGS. 6A-6B graphically illustrate example grids X created in HSW color spaces and transformed to the YCbCr and RGB color spaces, respectively, according to an embodiment. In this particular example, the grid size is 13×5×9 and the range is [0,1] for each of the HSW dimensions. It is apparent from FIG. 6A that the grid Q in the YCbCr color space occupies only a part of the [0,1], [0,1], [0,1] cube. In contrast, the grid Q in the RGB color space occupies the [0,1], [0,1], [0,1] cube in full. In both cases, the grid points are properly aligned with the respective valid color-space boundaries. The edges connecting R=G=B=0 or R=G=B=1 on the RGB color-space boundaries have hue values {0, 1/6, 2/6, 3/6, 4/6, 5/6}. Therefore, to have grid points placed exactly on these edges, the grid size in the H dimension can be selected in accordance with the formula 6n+1, where n is a positive integer. Other edges on the RGB color-space boundaries have the saturation value 1, which causes those edges to have grid points thereon regardless of any specific grid size.

Typically, the DM metadata L1-mid of an HDR image represent the mean of the image's RGB channels. However, in the process (200), the RGB channels of the output HDR image (240) depend on a chroma offset (230) (see FIG. 2). As a result, the DM metadata L1-mid need to be estimated. According to an example embodiment, such an estimate (222) is obtained using the initial HDR image (216). More specifically, the estimate (222) of the DM metadata Lt-mid, denoted as m, can be calculated as the mean of the Y channel of the initial HDR image (216) as follows:

$$\hat{m} = \frac{1}{N} {\sum }_{i = 0}^{N - 1} {v}_{i}^{( i n it ) , Y} \qquad ( 13 )$$

Referring back to FIG. 2, in an example embodiment, the 5-D LUT (D (228) used in the chroma offset processing block (220) of the process (200) can be defined on a 5-D grid X in the HSWLM space. In operation, the 5-D LUT Φ (228) outputs the chroma offset (230) in response to an input vector (226) defined in the HSWLM space. The input vector (226) is composed using the HSW channels block (224), the reshaping-function index map (212), and the estimate (222) of the DM metadata L1-mid. An example training process that can be used to populate the 5-D LUT (228) is described in more detail below (e.g., see FIGS. 7-8). The chroma offset (230) obtained using the 5-D LUT (228) is added (232) to the initial HDR image (216), thereby producing the output HDR image (240). The DM block (135) then processes the output HDR image (240) to generate the output DM image (137).

In an example embodiment, the above-described linear interpolation may be used to determine the chroma offset (230) for different pixels, e.g., on a pixel-by-pixel basis. Herein, the linear interpolation operation is denoted as \hat{φ}. For the i-th pixel, the chroma offset

$${r}_{i}^{C b C r} = ( {r}_{i}^{C b} , {r}_{i}^{C r} )$$

can be calculated as:

$${r}_{i}^{C b C r} = \hat{ϕ} ( {s}_{i}^{H} , {s}_{i}^{S} , {s}_{i}^{W} , {l}_{i} , \hat{m} ) \qquad ( 14 )$$

Eq. (14) can be used to program the chroma offset processing block (220) to determine the chroma offset (230). The i-th pixel in the output HDR image (240) can be calculated as:

$${v}_{i}^{YCbCr} = {v}_{i}^{( init ) , YCbCr} + ( 0 , {r}^{Cb} , {r}^{Cr} ) \qquad ( 15 )$$

Eq. (15) can be used to configure the adder (232) of the chroma offset processing block (220). If one denotes the R, G and B channels of the i-th pixel in the output HDR image V (240) as

$${v}_{i}^{RGB} = ( {v}_{i}^{R} , {v}_{i}^{G} , {v}_{i}^{B} ) ,$$

then the DM metadata L1-mid, which is defined as the mean of all R, G, and B channels, can be expressed as follows:

$$m = \frac{1}{3 N} {\sum }_{i = 0}^{N - 1} {v}_{i}^{R} + {v}_{i}^{G} + {v}_{i}^{B} \qquad ( 16 )$$

If one denotes the output DM image (137) as Ŝ, then the i-th pixel

$${\hat{s}}_{i}^{Y C b C r} = ( {\hat{s}}_{i}^{Y} , {\hat{s}}_{i}^{C b} , {\hat{s}}_{i}^{C r} )$$

in Ŝ can be represented as:

$${\hat{s}}_{i}^{Y C b C r} = {f}^{( D M )} ( {v}_{i}^{Y C b C r} , m ) \qquad ( 17 )$$

where ƒ^{(DM)} is the aforementioned DM function applied by the DM block (135).

### Parameter Learning

FIG. 7 is a flowchart illustrating a method (700) of populating the 5-D LUT (228) according to an embodiment. In an example embodiment, the method (700) relies on a cost function (704), which may typically include a color-shift term and one or more regularization terms. For each selected grid point (706) on a suitable (e.g., predefined as described above) 5-D grid (702), the method (700) includes iterative-minimization processing (708) configured to find the chroma offset (710) corresponding to an approximate minimum of the cost function (704) and using the found chroma offset to update (712) the nascent 5-D LUT (228). The method (700) further includes repeating the set of the processing operations (708), (710), (712) for a plurality of different selected grid points (706). An exit from this repetitive cycle occurs when an exit condition (714) is satisfied. After the exit, the method (700) includes outputting (716) the populated 5-D LUT and saving the same as the 5-D LUT (228) (also see FIG. 2).

In an example embodiment, the cost function (704) may be constructed to drive the iterative-minimization processing (708) into finding approximately optimal chroma offsets (710) that can correct the aforementioned color shifts on the 5-D grid X (702) for a plurality of grid points. For computational efficiency, the processing operations (708), (710), (712) may be configured to process one grid point at a time. Hereafter, for a selected grid point Xᵢ (706) of index i, the point's H, S, and W channels are denoted as

$${s}_{i}^{HSW} = ( {s}_{i}^{H} , {s}_{i}^{S} , {s}_{i}^{W} ) = ( {X}_{i , 0} , {X}_{i , 1} , {X}_{i , 2} ) ;$$

the reshaping function index is denoted as lᵢ=X_{i,3}; and the DM metadata L1-mid (222) is denoted as mᵢ=X_{i,4}. The corresponding HDR value of the initial HDR image (216) is

$${v}_{i}^{( init ) , YCbCr} = {f}_{l}^{( B )} ( {s}_{i}^{YCbCr} ) .$$

If the chroma offset (230) is not applied, then the HDR value

$${v}_{i}^{( init ) , YCbCr}$$

is passed to the DM block (135) to get the initial DM value

$${\hat{s}}_{i}^{( init ) , YCbCr} = {f}^{( DM )} ( {v}_{i}^{( init ) , YCbCr} , {m}_{i} ) .$$

On the other hand, if the chroma offsets r^{CbCr}=(r^{Cb},r^{Cr}) are applied to the Cb and Cr channels of the HDR value

$${v}_{i}^{( init ) , YCbCr} ,$$

a new HDR value,

$${v}_{i}^{YCbCr} = {v}_{i}^{( init ) , YCbCr} + ( 0 , {r}^{Cb} , {r}^{Cr} ) ,$$

is generated for the HDR image (240), and the final output DM value for the DM image (137) is

$${\hat{s}}_{i}^{YCbCr} = {f}^{( DM )} ( {v}_{i}^{YCbCr} , {m}_{i} ) .$$

In an example embodiment, it is desirable for the chroma offsets (710) to be able to significantly reduce (e.g., to an imperceptible level) or completely eliminate the SDR-to-HDR color shift. However, it is also desirable for the chroma offsets (710) not to create any artifacts or change the “look” of the images. As such, the cost function (704) may be constructed to include a color-shift term and one or more regularization terms to ensure stability. Because the cost function (704) considers only one grid point (706) at a time, the cost function (704) may be constructed to be insensitive to the location of the grid point (706) on the 5-D grid (702) and further to be insensitive to any specific topological features of the 5-D grid (702).

For illustration purposes and without any implied limitations, an example of the cost function (704) described below includes the following terms: a hue-difference cost Eₕᵤₑ, an offset cost E_{off}, a luminance change cost Eₗᵤₘ, a saturation change cost Eₛₐₜ, and a valid range cost E_{valid}. The total cost function Eₜₒₜₐₗ (704) is defined as:

$${E}_{total} = {E}_{hue} + {λ}_{off} {E}_{off} + {λ}_{lum} {E}_{lum} + {λ}_{sat} {E}_{sat} + {E}_{valid} \qquad ( 18 )$$

where λ_{off}, πₗᵤₘ, and λₛₐₜ are weighting constants. For the term E_{valid}, the weighting constant is one because this particular term's output value is either 0 or infinity. Example values of the other weighting constants may be λ_{off}=0.01, λₗᵤₘ=0.04, and λₛₐₜ=0.0025. In various other embodiments, the cost function (704) may have more or fewer cost terms. Some of the terms of such other cost function (704) may be different from the above-listed example cost terms.

The hue-difference cost Eₕᵤₑ is a color shift term. In an example embodiment, a color shift may be measured by the difference in hue in the HSV color space. It should also be noted that, when an SDR image has a neutral color, its hue may be undefined, and its saturation may be 0. Measuring the color shift by way of the changes in saturation in the HSV color space may typically help to properly handle such occurrences. Let us denote the H, S, and V channels of the input SDR value and the final output DM value as

$${s}_{i}^{HSV} = ( {s}_{i}^{H} , {s}_{i}^{S} , {s}_{i}^{V} ) and {\hat{s}}_{i}^{HSV} = ( {\hat{s}}_{i}^{H} , {\hat{s}}_{i}^{S} , {\hat{s}}_{i}^{V} ) ,$$

respectively. The hue-difference cost Eₕᵤₑ can then be defined as:

$${E}_{hue} = \{ \begin{matrix}max ( {{diff}_{hue} ( {\hat{s}}_{i}^{H} , {s}_{i}^{H} )}^{2} - {θ}_{hue} , 0 ) & if {s}_{i}^{S} > 0 \\ max ( {( {\hat{s}}_{i}^{S} )}^{2} - {θ}_{sat} , 0 ) & otherwise\end{matrix} \qquad ( 19 )$$

where θₕᵤₑ and θₛₐₜ are the thresholds of acceptable color shift. The function diffₕᵤₑ(a, b)=min(|a−b|, 1−|a−b|) can be used to measure the difference in hue, e.g., because the maximum difference in hue is 0.5. From equation (19), it can be seen that, for non-neutral color SDR values, i.e.,

$${s}_{i}^{S} > 0 , when {{diff}_{hue} ( {\hat{s}}_{i}^{H} , {s}_{i}^{H} )}^{2} \leq {θ}_{hue} ,$$

the hue-difference cost Eₕᵤₑ is 0. On the other hand, for a neutral color SDR value, i.e.,

$${s}_{i}^{S} = 0 ,$$

when

$${( {\hat{s}}_{i}^{S} )}^{2} \leq {θ}_{sat} ,$$

the hue-difference cost Eₕᵤₑ is also 0. In an example embodiment, the parameter values for equation (19) may be θₕᵤₑ=0.008² and θₛₐₜ=0.008².

The offset cost E_{off} is a regularization term configured to regularize the chroma offset to a reasonable range and to avoid overfitting. Such offset cost E_{off} may be defined as:

$${E}_{off} = {‖ {r}^{CbCr} ‖}_{2}^{2} = {( {r}^{Cb} )}^{2} + {( {r}^{Cr} )}^{2} \qquad ( 20 )$$

From equation (20), it can be seen that the offset cost is at a minimum when r^{Cb}=r^{Cr}=0.

The luminance change cost Eₗᵤₘ is a regularization term configured to regularize the change in luminance caused by the chroma offset. Such luminance change cost Eₗᵤₘ can be defined as:

$${E}_{lum} = \{ \begin{matrix}{{β}_{neg} ( {\hat{s}}_{i}^{Y} - {\hat{s}}_{i}^{( init ) , Y} )}^{2} & if {\hat{s}}_{i}^{Y} < {\hat{s}}_{i}^{( init ) , Y} \\ {β}_{pos} {( {\hat{s}}_{i}^{Y} - {\hat{s}}_{i}^{( init ) , Y} )}^{2} & otherwise\end{matrix} \qquad ( 21 )$$

where β_{neg} and βₚₒₛ are weights for luminance change in darker and brighter directions, respectively. In an example embodiment, β_{neg}>βₚₒₛ, which means that, if the chroma offset makes the output DM value relatively darker, then the corresponding cost is relatively higher. The presence of the luminance change cost Eₗᵤₘ typically helps to preserve a highlighted look in the HDR images (240). From equation (21), it can be seen that the luminance change cost is at a minimum when the chroma offset is not applied, i.e., when r^{Cb}=r^{Cr}=0. In an example embodiment, the parameter values for equation (21) may be β_{neg}=4 and βₚₒₛ=1.

The saturation change cost Eₛₐₜ is a regularization term configured to regularize the change in saturation caused by the chroma offset. Such saturation change cost Eₛₐₜ can be defined as:

$${E}_{sat} = {( {\hat{s}}_{i}^{S} - {\hat{s}}_{i}^{( i n i t ) , S} )}^{2} \qquad ( 22 )$$

From equation (22), it can be seen that the larger the change in saturation, the higher the saturation change cost. The presence of the saturation change cost Eₛₐₜ typically helps to preserve the relative look of the HDR images (240). The saturation change cost is at a minimum when the chroma offset is not applied, i.e., r^{Cb}=r^{Cr}=0.

The valid range cost E_{valid} is a regularization term configured to confine the new HDR values to a valid range. Such valid range cost E_{valid} can be defined as:

$${E}_{valid} = \{ \begin{matrix}0 & if {r}^{Cb} = {r}^{Cb} = 0 or 0 \leq {v}_{i}^{R} , {v}_{i}^{G} , {v}_{i}^{B} \leq 1 \\ ∞ & otherwise\end{matrix} \qquad ( 23 )$$

where

$$( {v}_{i}^{R} , {v}_{i}^{G} , {v}_{i}^{B} )$$

are the R, G, and B channels of the corresponding HDR value. When

$$0 \leq {v}_{i}^{R} , {v}_{i}^{G} , {v}_{i}^{B} \leq 1 ,$$

the HDR value is within the valid range, and the corresponding valid range cost is 0. In addition, for numerical stability, if there is no chroma offset, i.e., r^{Cb}=r^{Cb}=0 the valid range cost is also set to 0. Otherwise, the valid range cost is set to infinity.

FIG. 8 is a flowchart illustrating the iterative-minimization processing (708) according to an embodiment. The iterative-minimization processing (708) uses the cost function (704), e.g., the total cost function Eₜₒₜₐₗ of equation (18). Inputs to the iterative-minimization processing (708) include a grid point Xᵢ(804) and initial values (802) of the chroma offset and step size. An output of the iterative-minimization processing (708) includes the chroma offset (710) corresponding to a minimum of the cost function (704). The chroma offset (710) obtained in this manner may typically be stored in the 5-D LUT (228). For computational efficiency, the iterative-minimization processing (708) is configured to find the chroma offset (710) within a relatively small local range specified for a computing block (806). A corresponding processing loop, including a block (808) for calculating the values of the cost function (704), is run until convergence (814) or the maximum number of iterations tₘₐₓ (812) is reached. The step size can be changed (typically reduced) at a change block (816) to cause the chroma offset (710) to better correspond to the actual minimum of the cost function (704) within the used local range. For computational efficiency, the step size is not allowed to be smaller than a specified fixed minimum step size, which is checked at a step-size-check block (818).

In an example embodiment, the initial value (802) of the chroma offset may be set to

$${r}_{0}^{C b C r} = ( 0 , 0 ) .$$

At the t-th iteration for t≥1, the local range

$${R}_{t}^{C b C r}$$

for the processing block (806) can be set as follows:

$${R}_{t}^{C b C r} = \{ {r}_{t - 1}^{C b C r} + Δ {r}_{t} \times ( {m}^{C b} , {m}^{C r} ) \vert - k \leq {m}^{C b} , {m}^{C r} \leq k \} \qquad ( 24 )$$

where

$${r}_{t - 1}^{C b C r} = ( {r}_{t - 1}^{C b} , {r}_{t - 1}^{C r} )$$

is the estimated chroma offset from previous iteration; Δrₜ is the current step size; and k is a constant that controls the size of the local range. Then, a best chroma offset (810) at the current iteration can be expressed as:

$${r}_{t}^{CbCr} = arg {min}_{{r}^{C b C r} ∈ {R}_{t}^{CbCr}} {E}_{t o t a l} \qquad ( 25 )$$

If the iterative-minimization processing (708) reaches the maximum number of iterations tₘₐₓ at the counter block (812), then the chroma offset (710) is set to

$${r}^{{CbCr}^{*}} = {r}_{t}^{C b C r} .$$

Otherwise, if the estimated chroma offset is determined (814) to be at the local minimum, i.e.,

$${r}_{t}^{C b C r} = {r}_{t - 1}^{C b C r} ,$$

the step size for the next iteration may be reduced (816) to Δrₜ₊₁=αΔrₜ, where α<1 is a constant. The value of α may typically be chosen to achieve a desired speed of convergence. If

$${r}_{t}^{C b C r} \neq {r}_{t - 1}^{C b C r} ,$$

then the processing may proceed with Δrₜ₊₁=Δrₜ. The accuracy of the chroma offset (710) may typically be controlled by the constant Δrₘᵢₙ. If Δrₜ₊₁<Δrₘᵢₙ, then the convergence criterion is considered to be satisfied, and the output chroma offset (710) is set to

$${r}^{C b C {r}^{*}} = {r}_{t}^{C b C r} .$$

In an example embodiment, the following parameter values may be used: Δr₁=10⁻³, Δrₘᵢₙ=10⁻⁶, α=0.5, tₘₐₓ=100. In some embodiments, the value of Δrₘᵢₙ may be in the range between approximately 10⁻³ and 10⁻⁶ as the visual quality of the corresponding output HDR images (137) may still be acceptable for certain applications even at the top of this range.

According to an example embodiment disclosed above, e.g., in the summary section and/or in reference to any one or any combination of some or all of FIGS. 1-8, provided is an apparatus including a video delivery system capable of changing a dynamic range of an input image, the delivery system comprising: a memory (e.g., 228, FIG. 2) to store a plurality of chroma-offset values corresponding to grid points of a five-dimensional grid; and a processor (e.g., 120, FIG. 1) to convert the input image (e.g., 117, FIG. 2) having a first dynamic range (e.g., SDR, FIG. 2) into a corresponding output image (e.g., 240, FIG. 2) having a larger second dynamic range (e.g., HDR, FIG. 2), the processor being configured to: generate an intermediate image (e.g., 216, FIG. 2) having the second dynamic range by reshaping (e.g., 210, FIG. 2) the input image, the reshaping being performed using a reshaping-function index map (e.g., 212, FIG. 2) having, for each pixel of the intermediate image, a respective index identifying a corresponding reshaping function applied to the pixel; estimate (e.g., 222, FIG. 2) a display-management metadata value corresponding to the intermediate image; and generate the output image by applying (e.g., 232, FIG. 2) a respective chroma offset (e.g., 230, FIG. 2) to each pixel of the intermediate image, the respective chroma offset being determined from the plurality of chroma-offset values by addressing the grid points using the respective index, the display-management metadata value, and three respective pixel values of a corresponding pixel of the input image.

In some embodiments of the above apparatus, the first dynamic range is a standard dynamic range (e.g., SDR, FIG. 2); and wherein the second dynamic range is a high dynamic range (e.g., HDR, FIG. 2).

In some embodiments of any of the above apparatus, the three respective pixel values are a hue value, a saturation value, and an intensity value of the corresponding pixel of the input image.

In some embodiments of any of the above apparatus, the processor is further configured to nonlinearly rescale (e.g., V-to-W, 224, FIG. 2) intensity values of the input image; and wherein the three respective pixel values are a hue value, a saturation value, and a rescaled intensity value of the corresponding pixel of the input image.

In some embodiments of any of the above apparatus, the video delivery system is configured to generate a display-adapted image (e.g., 137, FIG. 2) by applying display-management processing to the output image.

In some embodiments of any of the above apparatus, the video delivery system comprises a video encoder (e.g., 120, FIG. 1) that includes at least a part of the processor.

In some embodiments of any of the above apparatus, the plurality of chroma-offset values is arranged in the memory in a lookup table addressable using reshaping-function index values, metadata values, hue values, saturation values, and intensity values.

In some embodiments of any of the above apparatus, the display-management metadata value corresponding to the intermediate image is an L1-mid luminance value.

In some embodiments of any of the above apparatus, the processor is further configured to perform linear interpolation of the chroma-offset values (e.g., Eqs. (6)-(11)) to determine the respective chroma offset.

According to another example embodiment disclosed above, e.g., in the summary section and/or in reference to any one or any combination of some or all of FIGS. 1-8, provided is a method of changing a dynamic range of an input image, the method comprising the steps of: converting the input image (e.g., 117, FIG. 2) having a first dynamic range (e.g., SDR, FIG. 2) into a corresponding output image (e.g., 240, FIG. 2) having a larger second dynamic range (e.g., HDR, FIG. 2), the converting being performed using a plurality of precomputed chroma-offset values corresponding to grid points of a five-dimensional grid; and wherein said converting comprises: generating an intermediate image (e.g., 216, FIG. 2) having the second dynamic range by reshaping (e.g., 210, FIG. 2) the input image, the reshaping being performed using a reshaping-function index map (e.g., 212, FIG. 2) having, for each pixel of the intermediate image, a respective index identifying a corresponding reshaping function applied to the pixel; estimating (e.g., 222, FIG. 2) a display-management metadata value corresponding to the intermediate image; and generating the output image by applying (e.g., 232, FIG. 2) a respective chroma offset (e.g., 230, FIG. 2) to each pixel of the intermediate image, the respective chroma offset being determined from the plurality of chroma-offset values by addressing the grid points using the respective index, the display-management metadata value, and three respective pixel values of a corresponding pixel of the input image.

In some embodiments of the above method, the method further comprises nonlinearly rescaling (e.g., V-to-W, 224, FIG. 2) intensity values of the input image; and wherein the three respective pixel values are a hue value, a saturation value, and a rescaled intensity value of the corresponding pixel of the input image.

In some embodiments of any of the above methods, the method further comprises generating a display-adapted image (e.g., 137, FIG. 2) by applying display-management processing to the output image.

In some embodiments of any of the above methods, the display-management metadata value corresponding to the intermediate image is an L1-mid luminance value.

In some embodiments of any of the above methods, said converting further comprises performing linear interpolation of the chroma-offset values (e.g., Eqs. (6)-(11)) to determine the respective chroma offset.

In some embodiments of any of the above methods, the plurality of chroma-offset values is arranged in a lookup table addressable using reshaping-function index values, metadata values, hue values, saturation values, and intensity values.

According to yet another example embodiment disclosed above, e.g., in the summary section and/or in reference to any one or any combination of some or all of FIGS. 1-8, provided is a non-transitory computer-readable medium storing instructions that, when executed by an electronic processor, cause the electronic processor to perform operations comprising a method of changing a dynamic range of an input image, the method comprising the steps of: converting the input image (e.g., 117, FIG. 2) having a first dynamic range (e.g., SDR, FIG. 2) into a corresponding output image (e.g., 240, FIG. 2) having a larger second dynamic range (e.g., HDR, FIG. 2), the converting being performed using a plurality of precomputed chroma-offset values corresponding to grid points of a five-dimensional grid; and wherein said converting comprises: generating an intermediate image (e.g., 216, FIG. 2) having the second dynamic range by reshaping (e.g., 210, FIG. 2) the input image, the reshaping being performed using a reshaping-function index map (e.g., 212, FIG. 2) having, for each pixel of the intermediate image, a respective index identifying a corresponding reshaping function applied to the pixel; estimating (e.g., 222, FIG. 2) a display-management metadata value corresponding to the intermediate image; and generating the output image by applying (e.g., 232, FIG. 2) a respective chroma offset (e.g., 230, FIG. 2) to each pixel of the intermediate image, the respective chroma offset being determined from the plurality of chroma-offset values by addressing the grid points using the respective index, the display-management metadata value, and three respective pixel values of a corresponding pixel of the input image.

According to yet another example embodiment disclosed above, e.g., in the summary section and/or in reference to any one or any combination of some or all of FIGS. 1-8, provided is a method of generating a plurality of chroma-offset values for performing color shift correction in an output image generated by changing a dynamic range of an input image, the method comprising the steps of: defining a five-dimensional grid (e.g., 702, FIG. 7) with first, second, third, fourth, and fifth dimensions thereof representing reshaping-function index values, metadata values, hue values, saturation values, and intensity values, respectively; defining a cost function (e.g., 704, FIG. 7) for quantifying at least a cost (e.g., Eq. (19)) for a hue difference between the input image and the output image; for each grid point (e.g., 804, FIG. 8) of the five-dimensional grid, performing iterative minimization of the cost function to determine a respective set of the chroma-offset values; and arranging the respective sets of the chroma-offset values in an electronic lookup table (e.g., 228, FIG. 2) addressable using sets of discrete values corresponding to the first, second, third, fourth, and fifth dimensions.

In some embodiments of the above method, said defining the cost function comprises including in the cost function one or more regularization terms configured to keep the iterative minimization within valid bounds.

In some embodiments of any of the above methods, the iterative minimization is performed within a local range of parameters (e.g., 806, FIG. 8) that is narrower than a full range of parameters.

In some embodiments of any of the above methods, the iterative minimization is performed using a variable step size (e.g., 818, FIG. 8).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

Various aspects of the present invention may be appreciated from the following enumerated example embodiments (EEEs):
EEE1. A video delivery system capable of changing a dynamic range of an input image, the delivery system comprising:
   a memory to store a plurality of chroma-offset values corresponding to grid points of a five-dimensional grid; and
   a processor to convert the input image having a first dynamic range into a corresponding output image having a larger second dynamic range, the processor being configured to:
      generate an intermediate image having the second dynamic range by reshaping the input image, the reshaping being performed using a reshaping-function index map having, for each pixel of the intermediate image, a respective index identifying a corresponding reshaping function applied to the pixel;
      estimate a display-management metadata value corresponding to the intermediate image; and
      generate the output image by applying a respective chroma offset to each pixel of the intermediate image, the respective chroma offset being determined from the plurality of chroma-offset values by addressing the grid points using the respective index, the display-management metadata value, and three respective pixel values of a corresponding pixel of the input image.
EEE2. The video delivery system of EEE 1,
   wherein the first dynamic range is a standard dynamic range; and
   wherein the second dynamic range is a high dynamic range.
EEE3. The video delivery system of EEE 1 or EEE 2, wherein the three respective pixel values are a hue value, a saturation value, and an intensity value of the corresponding pixel of the input image.
EEE4. The video delivery system of any of EEEs 1-3,
   wherein the processor is further configured to nonlinearly rescale intensity values of the input image; and
   wherein the three respective pixel values are a hue value, a saturation value, and a rescaled intensity value of the corresponding pixel of the input image.
EEE5. The video delivery system of any of EEEs 1-4, wherein the video delivery system is configured to generate a display-adapted image by applying display-management processing to the output image.
EEE6. The video delivery system of any of EEEs 1-5, wherein the video delivery system comprises a video encoder that includes at least a part of the processor.
EEE7. The video delivery system of any of EEEs 1-6, wherein the plurality of chroma-offset values is arranged in the memory in a lookup table addressable using reshaping-function index values, metadata values, hue values, saturation values, and intensity values.
EEE8. The video delivery system of any of EEEs 1-7, wherein the display-management metadata value corresponding to the intermediate image is an average luminance value.
EEE9. The video delivery system of any of EEEs 1-8, wherein the processor is further configured to perform linear interpolation of the chroma-offset values to determine the respective chroma offset.
EEE10. A method of changing a dynamic range of an input image, the method comprising:
   converting the input image having a first dynamic range into a corresponding output image having a larger second dynamic range, the converting being performed using a plurality of precomputed chroma-offset values corresponding to grid points of a five-dimensional grid; and
   wherein said converting comprises:
      generating an intermediate image having the second dynamic range by reshaping the input image, the reshaping being performed using a reshaping-function index map having, for each pixel of the intermediate image, a respective index identifying a corresponding reshaping function applied to the pixel;
      estimating a display-management metadata value corresponding to the intermediate image; and
      generating the output image by applying a respective chroma offset to each pixel of the intermediate image, the respective chroma offset being determined from the plurality of chroma-offset values by addressing the grid points using the respective index, the display-management metadata value, and three respective pixel values of a corresponding pixel of the input image.
EEE11. The method of EEE 10, further comprising nonlinearly rescaling intensity values of the input image; and
   wherein the three respective pixel values are a hue value, a saturation value, and a rescaled intensity value of the corresponding pixel of the input image.
EEE12. The method of EEE 10 or EEE 11, further comprising generating a display-adapted image by applying display-management processing to the output image.
EEE13. The method of any of EEEs 10-12, wherein the display-management metadata value corresponding to the intermediate image is an average luminance value.
EEE14. The method of any of EEEs 10-13, wherein said converting further comprises performing linear interpolation of the chroma-offset values to determine the respective chroma offset.
EEE15. The method of any of EEEs 10-14, wherein the plurality of chroma-offset values is arranged in a lookup table addressable using reshaping-function index values, metadata values, hue values, saturation values, and intensity values.
EEE16. A non-transitory computer-readable medium storing instructions that, when executed by an electronic processor, cause the electronic processor to perform operations comprising the method of any of EEEs 10-15.
EEE17. A method of generating a plurality of chroma-offset values for performing color shift correction in an output image generated by changing a dynamic range of an input image, the method comprising:
   defining a five-dimensional grid with first, second, third, fourth, and fifth dimensions thereof representing reshaping-function index values, metadata values, hue values, saturation values, and intensity values, respectively;
   defining a cost function for quantifying at least a cost for a hue difference between the input image and the output image;
   for each grid point of the five-dimensional grid, performing iterative minimization of the cost function to determine a respective set of the chroma-offset values; and
   arranging the respective sets of the chroma-offset values in an electronic lookup table addressable using sets of discrete values corresponding to the first, second, third, fourth, and fifth dimensions.
EEE18. The method of EEE 17, wherein said defining the cost function comprises including in the cost function one or more regularization terms configured to keep the iterative minimization within valid bounds.
EEE19. The method of EEE 17 or EEE 18, wherein the iterative minimization is performed within a local range of parameters that is narrower than a full range of parameters.
EEE20. The method of any of EEEs 17-19, wherein the iterative minimization is performed using a variable step size.
EEE21. The method of any of EEEs 17-20, wherein, for a t-th iteration of the iterative minimization, a respective best chroma offset

$${r}_{t}^{C b C r}$$

is determined as

$${r}_{t}^{C b C r} = arg {min}_{{r}^{CbCr} ∈ {R}_{t}^{CbCr}} {E}_{total} , where {R}_{t}^{CbCr}$$

is a minimization range, and Eₜₒₜₐₗ is the cost function.
EEE22. The method of any of EEEs 17-21, wherein the cost function includes a weighted sum of a hue-difference cost Eₕᵤₑ, an offset cost E_{off}, a luminance change cost Eₗᵤₘ, a saturation change cost Eₛₐₜ, and a valid range cost E_{valid}.

1. A video delivery system capable of changing a dynamic range of an input image, the delivery system comprising:
a memory to store a plurality of chroma-offset values corresponding to grid points of a five-dimensional grid; and
a processor to convert the input image having a first dynamic range into a corresponding output image having a larger second dynamic range, the processor being configured to:
generate an intermediate image having the second dynamic range by reshaping the input image, the reshaping being performed using a reshaping-function index map having, for each pixel of the intermediate image, a respective index identifying a corresponding reshaping function applied to the pixel;
estimate a display-management metadata value corresponding to the intermediate image; and
generate the output image by applying a respective chroma offset to each pixel of the intermediate image, the respective chroma offset being determined from the plurality of chroma-offset values by addressing the grid points using the respective index, the display-management metadata value, and three respective pixel values of a corresponding pixel of the input image.

2. The video delivery system of claim 1,
wherein the first dynamic range is a standard dynamic range; and
wherein the second dynamic range is a high dynamic range.

3. The video delivery system of claim 1, wherein the three respective pixel values are a hue value, a saturation value, and an intensity value of the corresponding pixel of the input image.

4. The video delivery system of claim 1,
wherein the processor is further configured to nonlinearly rescale intensity values of the input image; and
wherein the three respective pixel values are a hue value, a saturation value, and a resealed intensity value of the corresponding pixel of the input image.

5. The video delivery system of claim 1, wherein the video delivery system is configured to generate a display-adapted image by applying display-management processing to the output image.

6. The video delivery system of claim 1, wherein the video delivery system comprises a video encoder that includes at least a part of the processor.

7. The video delivery system of claim 1, wherein the plurality of chroma-offset values is arranged in the memory in a lookup table addressable using reshaping-function index values, metadata values, hue values, saturation values, and intensity values.

8. The video delivery system of claim 1, wherein the display-management metadata value corresponding to the intermediate image is an average luminance value.

9. The video delivery system of claim 1, wherein the processor is further configured to perform linear interpolation of the chroma-offset values to determine the respective chroma offset.

10. A method of changing a dynamic range of an input image, the method comprising:
converting the input image having a first dynamic range into a corresponding output image having a larger second dynamic range, the converting being performed using a plurality of precomputed chroma-offset values corresponding to grid points of a five-dimensional grid; and
wherein said converting comprises:
generating an intermediate image having the second dynamic range by reshaping the input image, the reshaping being performed using a reshaping-function index map having, for each pixel of the intermediate image, a respective index identifying a corresponding reshaping function applied to the pixel;
estimating a display-management metadata value corresponding to the intermediate image; and
generating the output image by applying a respective chroma offset to each pixel of the intermediate image, the respective chroma offset being determined from the plurality of chroma-offset values by addressing the grid points using the respective index, the display-management metadata value, and three respective pixel values of a corresponding pixel of the input image.

11. The method of claim 10, further comprising nonlinearly rescaling intensity values of the input image; and
wherein the three respective pixel values are a hue value, a saturation value, and a rescaled intensity value of the corresponding pixel of the input image.

12. The method of claim 10, further comprising generating a display-adapted image by applying display-management processing to the output image.

13. The method of claim 10, wherein the display-management metadata value corresponding to the intermediate image is an average luminance value.

14. The method of claim 10, wherein said converting further comprises performing linear interpolation of the chroma-offset values to determine the respective chroma offset.

15. The method of claim 10, wherein the plurality of chroma-offset values is arranged in a lookup table addressable using reshaping-function index values, metadata values, hue values, saturation values, and intensity values.
